(19) United States
(12) Patent Application Publication
(10) Pub. No.: US 2007/0062397 A1
(43) Pub. Date: Mar. 22, 2007

(54) Sheet offset machine, drier and method for drying in sheet offset machine

(75) Inventor: Erik Gydesen, Vejle (DK)

Correspondence Address: James C Wray, Suite 300, 1493 Chain Bridge Road, McLean, VA, 22101, US

(73) Assignee: Tresu Anlaeg A/S, Bjert (DK)

(21) Appl. No.: 10/572,244

(22) PCT Filed: Sep. 17, 2004
(86) PCT No.: PCT/DK04/00631

§ 371 Date: Sep. 11, 2006

(30) Foreign Application Priority Data
Sep. 18, 2003 (DK) PA 2003 01358

(51) Int. Cl. B41F 23/04

(52) U.S. Cl. 101/424.1; 101/488

(57) ABSTRACT

The invention describes a sheet offset machine in which may be applied an air-drying ink/varnish. The invention furthermore concerns a drying unit that may be used for drying air-drying ink/varnish. The drying unit is disposed in connection with a cylinder surface and includes an integrated ventilator with suction and exhaust duct. These are used for sucking in fresh air and for exhausting used air having swept a wet print on the print carrier. The ventilator is connected to nozzles having an elongated nozzle orifice oriented in parallel with the center axis of the cylinder surface. The nozzle orifice is provided immediately opposite the cylinder surface for blowing an air stream towards counter pressure on the print carrier while it is disposed on the cylinder surface. By using such a system is achieved an efficient and energy economical drying of the applied inks/varnishes.

### FIELD OF THE INVENTION

The present invention concerns a sheet offset machine modified for applying an air-drying ink/varnish in at least one printing unit.

The invention also concerns a drying unit for use in a sheet offset machine which is possibly modified for applying an air-drying ink/varnish in at least one printing unit.

The invention furthermore concerns a method for drying an air-drying ink/varnish in a sheet offset machine by injecting an air stream against a print on a print carrier while the latter is moved past a drying unit.

### BACKGROUND OF THE INVENTION

It will be possible to use the drying unit in a sheet offset machine, where one or more of the printing units is a modified printing unit which optionally can be used for offset printing or flexographic printing. Alternatively, a drying unit can be used in a varnishing unit in a sheet offset machine, irrespectively whether the machine has been modified or not. It is also possible to use the drying unit after the last printing unit/varnishing unit in a sheet offset machine irrespectively whether it has been modified or not

By indicating a modified sheet offset machine such as used in the present patent application is meant a sheet offset machine in which is applied ink and/or varnish that may be air-dried. The invention thus concerns drying of all inks and varnishes that can be used in a sheet offset machine and which can be air-dried (that does not require UV drying).

A sheet offset machine is used for offset printing where the print carriers are inserted one by one in the shape of sheets. The print carrier is preferably of water-absorbing materials, as e.g. paper and cardboard, but may also be of non-water-absorbing materials as e.g. plastic, films, metallised paper and cardboard, and even metal. The offset printing can be combined with flexographic printing or varnish/ink application in one or more separate in-line printing units and/or one or more offset printing units that may be modified to in-line varnishing units by providing it with a flexographic varnish/ink application unit, preferably in the shape of a doctor blade unit including a doctor blade and a screen roller which are brought to engage the rubber blanket cylinder of the printing unit for transferring ink/varnish to the print carrier at its passage between the rubber blanket cylinder and a counter pressure cylinder.

In prior art sheet offset machines, drying (except UV drying) will usually be performed with a drying unit disposed after the last printing unit and/or varnishing unit of a machine in the subsequent distributor that may have different length, depending on the type of machine. Such a drying unit is called a final dryer.

A final dryer for drying oxidising oil-based offset inks is normally an IR dryer with short-, intermediate and/or long-wave IR lamps. This dryer is normally disposed in the turn-up of the gooseneck of the conventional distributor. A final dryer for drying a combination of oxidising oil-based offset inks and dispersion varnishes (aqueous varnishes) is normally an IR dryer combined with one or more air knives. This dryer is usually disposed both in the horizontal part of the extended distributor and the goose-neck.

The conventional final dryers are mounted in the distributor after the last printing unit or varnishing unit. A gripper rod with a width corresponding to that of the printing cylinders and with a row of grippers transversely of the rod transports the print sheet from the counter pressure cylinder of the last printing unit/varnishing unit and to the distributor stack. The gripper rod is mounted on a chain drive at both sides of the distributor. The assembled chain drive contains a row of gripper rods that are mounted successively with a spacing corresponding to the distance to the gripper rods in the counter pressure cylinder. The gripper stop itself is found at the underside of the gripper rod, and the wet side of the print sheet is facing upwards against the gripper rod. The sheet is only held at the front edge and may therefore flutter like a flag from the gripper rod during transport. In order to avoid that the conventional final dryer collides with the gripper rods and/or that the sheet flutters up and receives marks from the final dryer, this must necessarily be mounted at a certain distance over the gripper rods in the distributor itself This means that the distance between the dryer and the wet top side of the print sheet becomes at least equal to the thickness of the gripper rod plus the gripper (but often much greater), and this distance causes that it is difficult to remove the vapour pressure located immediately above the wet print. It may thus be said that the prior art final dryers are unfavourable, as both the IR rays and the injection air of the air knives are to travel a long distance before rays and air may sweep the wet sheet.

An example of a prior art drying unit is known from e.g. GB 905,942.

When using prior art drying units, a limitation in the flexibility for using a sheet offset machine with more printing units occurs. This may e.g. be the case in connection with applying a primer between an offset print and a superposed UV-varnish. In the prior art sheet offset machines, application of primer will necessitate that print carriers are provided two passes through the sheet offset machine.

Conventional multi-colour offset printing with both wet and dry offset is performed wet in wet, i.e. one wet offset ink is applied the print sheet upon another ink. The sheets are thus wet when they leave the last printing unit and are transported via the distributor and out into the stack. In order to prevent set-off from the wet, printed surface of one print sheet and over upon the dry, unprinted (or printed—by double side printing) back side of the succeeding sheet, normally a powder layer, so-called spray powder, is used which is sprayed in between the sheets after the last printing unit. This has negative impact on the quality of the printed matter and complicates further processing. The only way to eliminate the use of spray powder is to ensure that the sheet is dry when delivered to the stack. Under normal conditions this may only be ensured by printing with UV inks which via a chemical drying process ensure that the inks of the print sheet are completely dry when the print sheet comes out into the stack, or alternatively by applying a dispersive varnish (aqueous varnish) and ensure that the surface of this varnish is dry before the sheet reaches the stack in the distributor.

If one desires refining the print sheet with full gloss, a UV or dispersion gloss varnish may be used. If the full gloss with UV varnish is to be maintained, it can only be applied on UV inks (wet in wet or wet on dry) or upon conventional printing inks that are completely dry. Since the conventional oil-based offset inks are wet when the print sheet leaves the last printing unit, UV varnish cannot be applied on conventional offset inks in the same pass. The print sheet is to dry at first before the UV varnish can be applied in an additional pass. Dispersion varnish may, however, be applied on wet conventional printing inks, but the wetter the inks, the less the gloss becomes. This means that full gloss with both UV and dispersion varnish require varnishing on dry printing inks.

If one desires to refine a print sheet based on conventional printing inks with UV gloss varnish, dispersion gloss varnish or special effects (metal, nacreous, glue, scent etc.), this can only be done upon a dry surface on the printing sheet. The only method for achieving this dry surface upon conventional offset inks, before the above refining processes can be performed in the same pass, is to seal the wet surface of the offset inks with a dispersion varnish which is surface dried before the print sheet is applied the refining varnish. This requires an extra printing unit (flexo printing unit) or and offset printing unit which is modified to a varnishing unit (flexoprinting unit) before the refining varnish can be applied in a subsequent varnishing unit.

If one desires to refine a protecting varnish before the refining varnish, at least two inline varnishing units are required, where one can be a modified printing unit, and it is required that so much protecting varnish is applied on the sheet that all printing ink is covered. At the same time, it is required that the protecting varnish is dry before the refining varnish is applied. This requires either great distance between the varnishing unit applying the protecting varnish and the varnishing unit applying the refining varnish, or otherwise requiring a very efficient and compact dryer between the two varnishing units.

### PURPOSE OF THE INVENTION

It is the purpose of the present invention to indicate a sheet offset machine and a method that may be used for air-drying inks/varnishes as well as enabling to ensure an efficient and energy economic drying of the applied inks/varnishes. In particular, it is desired that the print carrier may be provided with further ink/varnish in an immediate subsequent printing unit in a sheet offset machine, or which alternatively can be moved directly to stacking without any need for subsequent final drying or risk of “caking” occurring in the stack.

### DESCRIPTION OF THE INVENTION

According to the present invention, this may be achieved with a sheet offset machine of the kind mentioned in the introduction, which is peculiar in that a drying unit is provided, preferably associated with a cylinder surface, the drying unit including an integrated ventilator with suction and exhaust duct used for sucking fresh air and for exhausting used air which has swept the print on the print carrier, the ventilator furthermore being connected with nozzles having a nozzle duct opening into an elongated nozzle orifice with orientation in parallel with the centre axis of the cylinder surface and disposed opposite to the cylinder surface for blowing an air stream towards a print on the print carrier while it is situated thereon.

The drying unit according to the invention is peculiar in that it is preferably provided in association with a cylindrical surface in the sheet offset machine, the drying unit including an integrated ventilator with suction and exhaust duct used for sucking in fresh air and for exhausting used air which has swept the punt on the print carrier, the ventilator furthermore being connected with nozzles having a nozzle duct opening into an elongated nozzle orifice with orientation in parallel with the centre axis of the cylinder surface and disposed opposite to the cylinder surface for blowing an air stream towards a print on the print carrier while it is situated on the cylinder surface.

At least an outermost part of the nozzle duct bordering the nozzle orifice may be angled in relation to a position radially on the cylinder surface, so that the nozzle duct is directed against the direction of the movement of the print carrier past the drying unit.

According to a particular embodiment, the drying unit includes air withdrawal ducts which are arranged between succeeding nozzles and/or between the nozzles and sidewalls in the drying unit.

According to a particular embodiment, the air withdrawal ducts are provided with a plate at their orifice regions, the plate covering central parts of the orifice of the air withdrawal ducts at a level largely corresponding to the level of the nozzle orifices.

The cylinder surface may be provided in the shape of a counter pressure cylinder in a printing unit and/or varnishing unit or a transfer cylinder between succeeding printing units or a transfer roller after the last printing unit in the sheet offset machine.

According to a particular embodiment, the sheet offset machine is peculiar in that the nozzles and the withdrawal suction ducts are built into a common casing, that in the said casing there is also mounted a motor with ventilator which is connected to the withdrawal ducts and with air supply ducts that are connected with the nozzle ducts and the exhausting ducts so that a substantial part of the air sucked into the ventilator is recycled in the casing and reused for injection, and that this part preferably is more than 80%.

According to a further embodiment, the distance between the nozzle orifice and the surface of the print carrier is between 7 and 20 mm, preferably between 9 and 11 mm.

The angle of a nozzle duct relative to a radial orientation will preferably be between 2 and 45°, preferably between 4 and 10° and in particular between 5 and 7°. By using such an angling of the nozzle ducts in relation to the pressure, it appears that an optimal peeling effect is achieved for the vapour layer located over a wet ink print.

The method according to the invention is peculiar in that the injection occurs against the print while the print carrier is situated on a cylinder surface in the sheet offset machine, that an integrated ventilator with suction and exhaust duct is used for sucking in fresh air and for exhausting used air that has swept the print on the print carrier, that the ventilator furthermore is used for injecting air through nozzles having a nozzle duct opening into an elongated nozzle orifice with orientation in parallel with the centre axis of the cylinder surface.

Injection is performed at an angle in relation to a radial orientation so that the air stream is directed against the direction of movement of the print carrier past the drying unit.

According to a further embodiment, the method is peculiar in that the air withdrawal suction is performed at positions between succeeding air injections and/or between air injections and sidewalls in a drying unit, and that the air withdrawal suction is established in an orifice area which is partially blocked at central parts of an orifice region of an air withdrawal suction duct for forming a cushion of pressurised air immediately over the print to be dried.

It is preferred that the drying is effected with a high-speed air stream with airspeeds at the nozzle orifice in the magnitude between 20 and 75 m/s, preferably between 35 and 50 m/s.

The method is advantageous in that a substantial part of the air sucked in is recycled and reused for injection, and that that this part preferably is higher than 80%, as the nozzles and the withdrawal ducts are integrated in a common casing including suction and exhaust ducts as well as withdrawal suction ducts and injection ducts which are connected to the nozzle ducts.

By using nozzles that direct the pressure towards the print carrier while it is situated on a cylinder surface, preferably formed by a cylinder in a printing unit in the sheet offset machine, it becomes possible to perform drying of a wet print so that it may be moved directly to a succeeding printing unit for further processing, e.g. in the form of printing/varnishing or directly to stacking.

It has appeared possible to achieve sufficient drying effect when the nozzles are working with high pressure and with the nozzle duct angled so that the air stream is not directed perpendicularly to the wet print, but is directed towards the print at an angle. Hereby is achieved a sweeping effect that facilitates removing the vapours situated immediately above the wet print. Hereby, vapours may be brushed or blown away due to the high airspeed, and thereby it has appeared possible to achieve a drying of a print while it is situated on a cylinder in a printing unit.

Similar to the option of the system of drying between two succeeding printing units, the system may also be used as alternative to final drying by performing a drying while the print is in the last printing unit or varnishing unit in a sheet offset machine.

It is preferred that the drying unit has one or more elongated nozzle orifices that are oriented in parallel with the centre axis of the cylinder. Hereby is achieved an effect that almost corresponds to peeling the vapour away at the passage of the print past the nozzle orifice. Here it will be an advantage to have several succeeding nozzle orifices in order to increase the effect. However, it has also appeared that a high airspeed has substantial significance for the drying.

In order to achieve high airspeeds, it has appeared advantageous to provide withdrawal suction ducts between succeeding nozzles and/or between the nozzles and the sidewalls in the drying unit. These withdrawal suction ducts will normally have an outwards funnel-shaped opening due to tapering the outermost end of the nozzle ducts. It is therefore preferred that in the orifice areas of the air withdrawal suction ducts there is provided a plate covering a central part of the duct in the area corresponding to the nozzle orifice. At a short distance over the print is thus provided slotted air injection openings and air withdrawal openings.

By disposing such a plate in the orifice area of the air withdrawal suction ducts, it has appeared possible to avoid the suction effect otherwise occurring when the rear edge of a sheet is just passing an air injection nozzle. There has been a tendency that the pressure difference occurring will act as suction at the top side of the sheet so that it is drawn outwards. Such an outwards directed pull on a sheet situated on a cylinder will cause that the sheet may come in contact with the nozzles of the dryer or the sidewalls in the drying unit. By this there is a risk of damage to the sheet and/or the print.

As the distance between nozzles and the sheet will usually be very small and typically in the magnitude of 7-20 mm, preferably 9-11 mm, the risk of damage to the print will be considerable if cover plates are not used in the orifices of the air withdrawal suction ducts. The cover plates can be massive or be provided with perforations. By using these cover plates; a pressure curtain is formed between the sheet and the plate, contributing to keep the sheet down when passing an injection nozzle.

As mentioned, it is essential to work with substantial airspeeds. It is possible to work with such airspeeds without any risk that the sheets are pressed or sucked up and damaged when cover plates are used in the air withdrawal suction ducts.

By withdrawing the air in the drying unit itself is furthermore achieved the advantage of recycling the larger part of the swept air to a ventilator, so as to be injected again. It has appeared possible to achieve an efficient drying even if up to about 80-90% of the withdrawn air is reused. Furthermore, by such a construction is achieved an advantage of reduced need for dimensioning ducts for air suction and air exhaust. At the same time it will be possible to provide the drying unit as an independent unit which can be placed in a printing unit and which only requires electric supply for driving the ventilator.

It has appeared difficult to find suitable ventilators. However, it has appeared that it is possible to provide a motor which usually can be used as servomotor which otherwise is intended for precise servo-operation. These motors can be powered with very high speed and it is possible to provide these with an impeller at each end of the motor. Thus it will be possible to provide a ventilator by dismounting the ventilator of the motor itself and to mount an impeller which may contribute to provide high airspeed. Other motors may, however, also be used if just a needed balancing/adaptation is performed.

The motor/ventilator may be driven with speeds up to 6000 rpm, or higher, which at the same time enables providing high flow rate and a high pressure. Air suction ducts and withdrawal suction ducts may thus be built into a common casing in which the ventilator is also provided, so that the ventilator gets its suction air from the withdrawal suction ducts and has its exhaust in the nozzle ducts. The motor will preferably be provided with frequency regulation instead of a traditional servo-operation. With a technically simple and cheap solution it hereby becomes possible to regulate the motor to a high rotational speed while at the same time the motor may operate with high air temperature. In the common casing there may be provided a heat source in the form of an electric heating coil.

The drying unit may possibly be combined with an IR-drying element. By placing an IR-element right before the nozzles of the drying unit, it becomes possible to influence the movement of the vapour molecules. By enhancing the movement of the vapour molecules, it will be easier to achieve a blowing off or peeling off of the vapour layer over the wet print and thereby an improved efficiency of the drying.

A drying unit for a sheet offset machine according to the invention may be disposed at an intermediate printing unit in the sheet offset machine. Such an intermediate printing unit can be can be adapted for applying a primer which in principle consists of an aqueous varnish, and that a succeeding printing unit will be adapted for applying a UV-varnish. Usually, a sheet offset machine will not be capable of applying UV-varnish when a print carrier only performs one pass. An offset print printed on the print carrier should thus be applied a primer before applying UV-varnish. This is required in order to avoid that the UV-varnish is dissolved by the oil colours used in the offset printing.

Alternatively, it will be possible to use the drying unit in the intermediate printing unit with the intention of a more rational operation. Thus it will also be possible to dispose the drying unit in or after a final printing unit. It is possible to use the drying unit in a last printing unit which is simultaneously equipped with a unit for flexographic printing. Hereby it becomes possible to apply a protecting varnish in a final printing unit or varnishing unit and to dry the varnish, after which direct punching is enabled.

It is a significant advantage over traditional offset printing where the oil colours are to be dried for about 1 day before punching can be performed. By applying a protecting varnish which is to be dried subsequently, it becomes possible to punch in direct continuation of the last printing unit. Hereby, the total throughput time can be reduced compared with traditional offset printing/punching.

The unit will usually be disposed in association with a counter pressure cylinder, so that the print carrier is situated on the counter pressure cylinder when the drying is performed.

By using a system according to the invention, it has appeared possible to attain an increased capacity of 25% or more compared with normal offset printing with prior art offset printing machines with traditional final dryers. There is not only an energy saving by using the drying unit, but at the same time, an increased capacity can be attained with a sheet offset machine according to the invention.

With a system according to the invention one may say that high-speed motors are integrated that enable using ventilators with small diameters which provide high pressure and high speeds in the air inlet nozzles. As the drying unit can be built into a common casing, it is possible to build this in modular form which can be put directly into a sheet offset machine associated with existing rollers/cylinders which preferably will be counter pressure cylinders. The drying unit may thus be inserted directly for establishing drying on a printing unit in the sheet offset machine. Mounting of such a modular drying unit can be performed so that the other functions in the sheet offset machine are not disturbed. By using modular construction, mounting and dismounting may be effected very easily. Thus it becomes possible to change the function of the printing units optionally from offset printing to varnishing in a sheet offset machine by mounting or dismounting a modular drying unit in an arbitrary printing unit in the sheet offset machine.

Since the drying unit is provided with motors and is recycling a large part of the air internally, a drying unit may readily be mounted and moved arbitrarily from printing unit to printing unit as in principle is only requires a power supply. In the enclosure or outer wall of the casing there will be provided ventilation holes for sucking in a small amount of air for substituting the little amount of air exhausted. Since only a small amount of air is exhausted, there will only be a limited need for air exhaust ducts. There will be a rather small pressure loss in the recirculated air, meaning that there will not be a large energy loss at the air exhaust. The amount of air changed depends on the amount of vapour to be removed, but in practice it has appeared sufficient only to exchange 10-20% of the amount of air in order to achieve an efficient drying which is possible with short drying length provided on a cylinder surface in a printing unit/varnishing unit.

As there is used a drying unit with integrated motor, heat from the motor will heat up the air, thus improving the energy economy and efficiency of the system. In operation, the motor can heat room air to about 40° C. which may be a sufficient temperature level for achieving efficient drying effect.

### DESCRIPTION OF THE DRAWING

The invention will then be explained more closely with reference to the accompanying drawing, where:

FIG. 1 shows an elementary sketch of a sheet offset machine according to the invention,

FIG. 2 shows a partial view for illustrating two succeeding printing units, of which one is provided with a drying unit,

FIG. 3 shows a perspective view of a drying unit for the sheet offset machine according to the invention,

FIG. 4 shows a section through a drying unit, and

FIG. 5 shows a partial view for illustrating the operation of the drying according to the invention.

### DETAILED DESCRIPTION OF THE INVENTION

In the following, identical or corresponding elements will be designated with the same designation, and no specific explanation to all details in all Figures will be given.

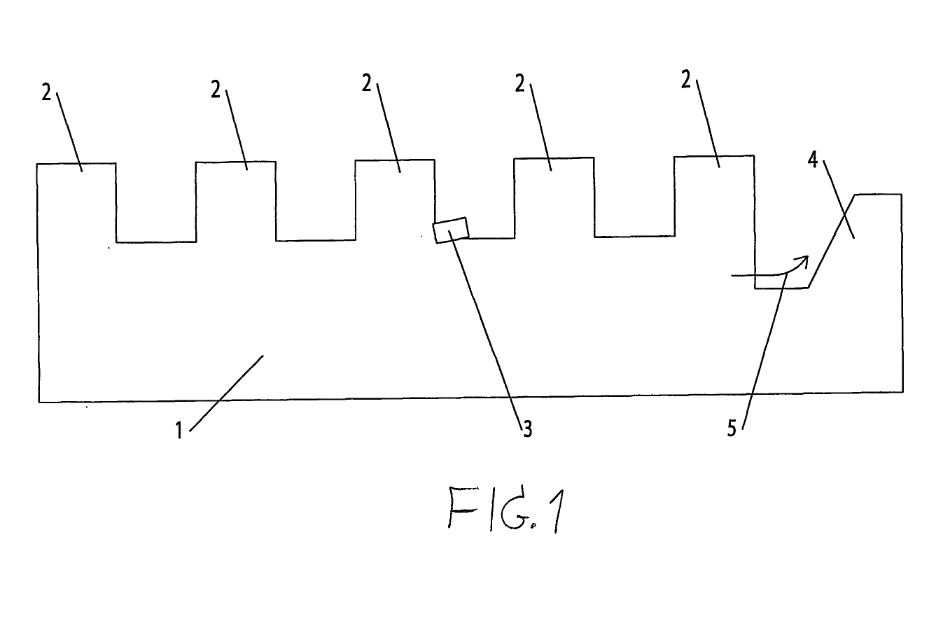

In FIG. 1 is shown a sheet offset machine 1 for offset printing. The sheet offset machine includes five printing units 2. In the third printing unit 2 there is provided a drying unit 3 according to the invention. The sheet offset machine furthermore includes a conveyor 4 conveying sheets passing through the sheet offset machine 1 to a stacker (not shown).

In FIG. 1, the position of the drying unit 3 is shown in an interposed printing unit 2. Alternatively, the drying unit 3 can be disposed after the last printing unit which is shown partially at the right for providing a final drying before stacking the printed sheets. Sheets are passed through the sheet offset machine in a direction indicated by an arrow 5.

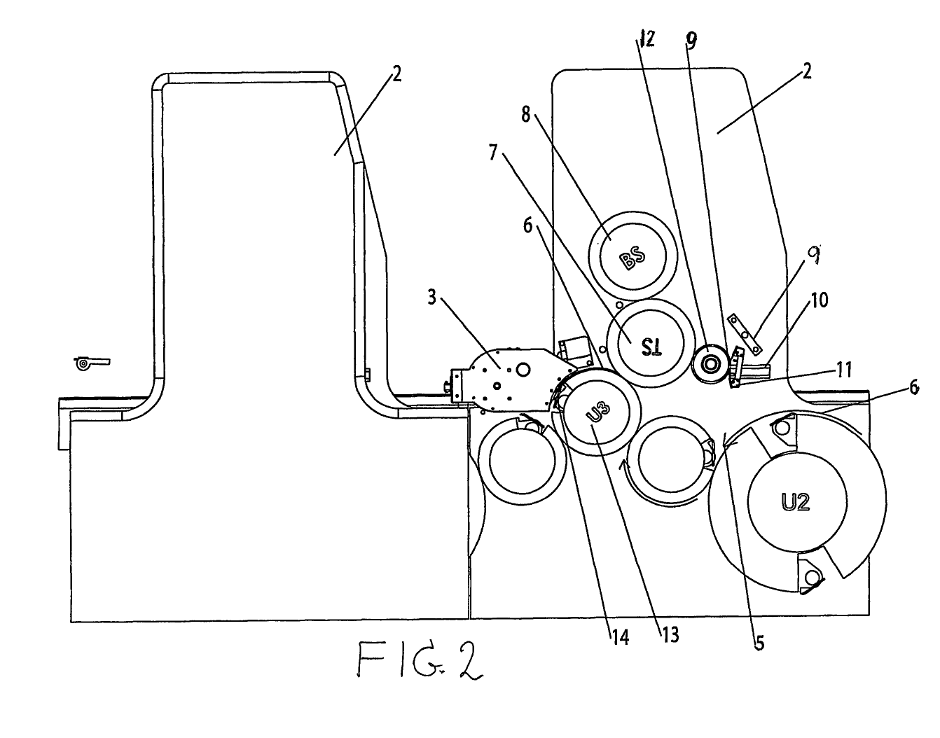

FIG. 2 illustrates a partial view of sheet offset machine 1, where two printing units 2 are shown and a drying unit 3. In the sheet offset machine, sheets 6 are conveyed through the sheet offset machine according to the arrow 5. The printing unit includes a rubber blanket cylinder 7 and a plate cylinder 8. The rubber blanket cylinder 7 may be in contact with a flexographic printing unit 9 which is suspended on a support holder 10 in the printing unit 2. The flexographic printing unit 9 includes a doctor blade 11 and a screen roller 12 which is in contact with the rubber blanket located on the rubber blanket cylinder 7. The print is thereby transferred to the sheet 6 when it is situated between the rubber blanket cylinder 7 and a counter pressure cylinder 13. The sheet is held in a gripping device 14 on the rubber blanket cylinder.

The drying unit 3 is disposed at a position opposite the counter pressure cylinder 13 for drying the wet print immediately after the print has been transferred from the rubber blanket to the sheet 6.

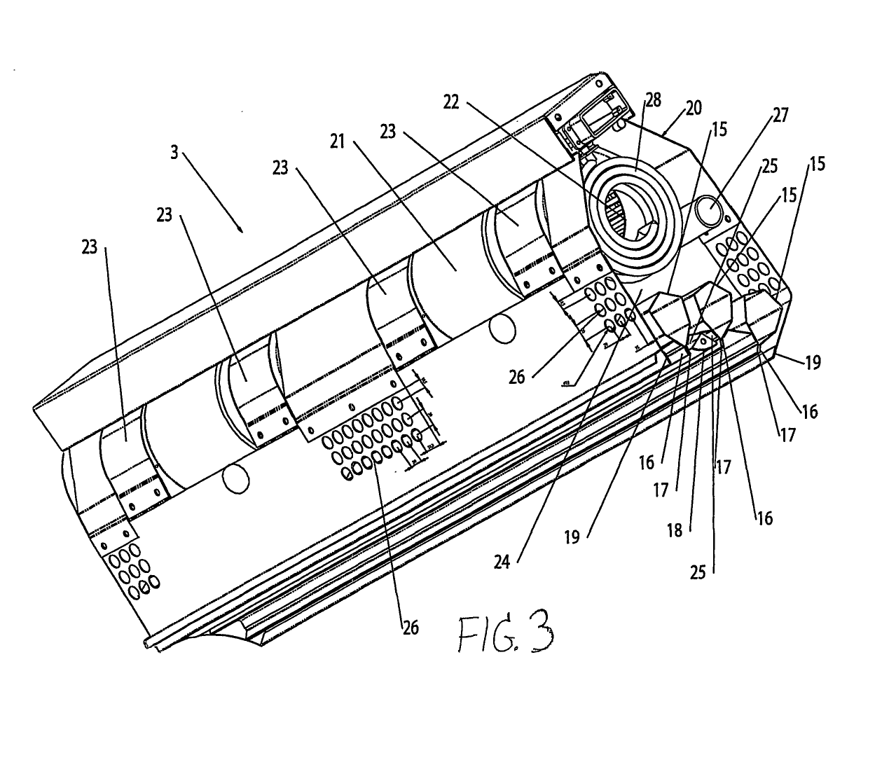

In FIG. 3 is shown a perspective view of the drying unit 13. It appears from this that the drying unit is provided with three nozzles 15 that are oblong and extend in parallel with a centre axis of the counter pressure cylinder 13. Each of the nozzles are provided with an outermost duct 16 that has a nozzle orifice 17 which in use is intended to be disposed about 9-11 mm over the sheet 6. Between each of the nozzles 15 there is provided a cover plate 18, of which only one is shown in FIG. 3. A corresponding cover plate is disposed in the interspace between the outermost nozzles and sidewalls 19 in the casing 20 of the drying unit 3.

The casing 20 of the drying unit encloses a motor 21 which at each end is provided with a ventilator 22, of which only one is partly visible in the Figure. The ventilators are disposed in pressure chambers 23 that communicate with the nozzles 15. Between the pressure chambers 23 there is an open chamber 24 communicating with the inlet to the ventilators 22 and which also stands in inlet with withdrawal suction ducts 25 provided in the interspaces between the cover plates 18 and the nozzle ducts 16. The air is thus recycled in the casing of the drying unit and only a minor amount of air is exhausted to the surroundings. In the casing 20, ventilation openings 26 are provided, communicating with the chamber 24. Via these ventilation openings 26, air suction is performed for substituting the amount of air exhausted via an exhaust duct 27. This amount of air constitutes about 10-20% of the circulated air.

In the drying unit 3, an electric heating coil 28 is provided at the inlet to the ventilators 22. Hereby it becomes possible to heat the air before injection via the nozzles 15. It is noted that the casing of the drying unit is divided by partitionings (not shown) separating pressure chambers and suction chambers within the sidewalls of the casing.

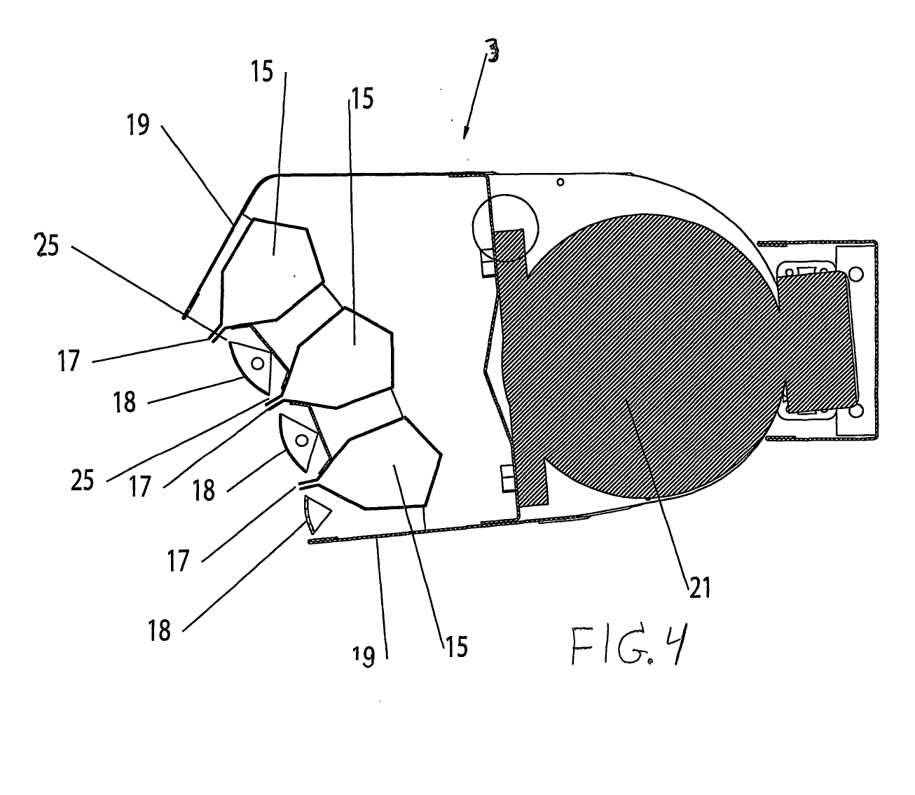

FIG. 4 illustrates a section through the drying unit. It is seen here that cover plates 18 are provided between the three nozzles 15 and the sidewalls 19. The cover plates are provided at a level corresponding to the disposition of the nozzles orifices 17 so that the orifice of the withdrawal suction ducts is disposed at the same level. In use, this means that between a sheet and the drying unit an air curtain is formed, counteracting the risk that sheets are sucked/blown towards the drying unit and giving rise to damage on the sheet and/or the print.

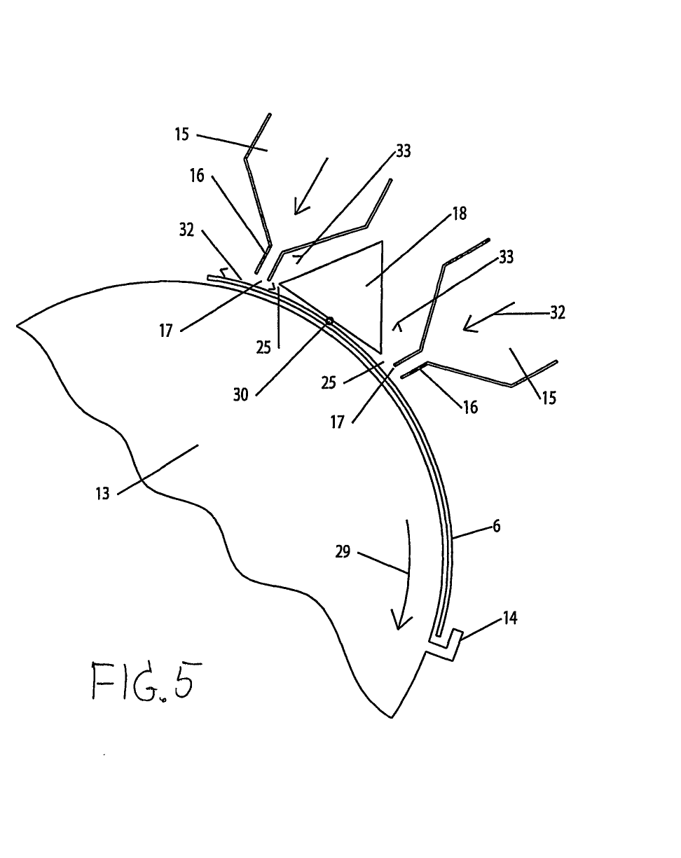

FIG. 5 is a schematic view of the counter pressure cylinder 13 on which a sheet 6 is fixed by means of the gripping means 14. Rotation is in the direction of arrow 29. Here it is seen clearly that the orifices 17 for the nozzles 15 and the nozzles 25 for the air withdrawal suction ducts are at the same level immediately over the sheet 6. An interspace 30 between the sheet 6 and the cover plate 18 is formed, where a pressure preventing the rear end 31 of the sheet 6 from swinging out or being sucked out due to the pressure differences existing at passage of a pressurised air nozzle, where air flows out according to the arrows 32 before the air is sucked out by the withdrawal suction ducts according to the arrows 33.

Appearing from FIG. 5, the outermost duct section 16 of the nozzles 15 will be inclined in relation to a direct radial orientation. In the shown embodiment, the inclination will be between 5 and 7° relative to a radial orientation directly against a centre axis for the counter pressure cylinder 13.

In the above, the invention is explained with reference to specific embodiments, but modifications are possible in the light of the following claims. A drying unit may thus include fewer or more than three nozzles, preferably up to ten nozzles and intermediate cover plates may be designed as fixed plates or perforated plates. It will also be possible to dispose a drying unit in connection with an arbitrary printing unit 2 in a sheet offset machine 1.

Furthermore, air injection may be differentiated so that a first air injection may be heated and the second air injection may be cooled in order thereby to cool the varnish and reduce the tendency to sticking.

1. A sheet offset machine for applying air-drying ink/varnish in at least one printing unit, at which there is provided a drying unit, preferably associated with a cylinder surface, the drying unit including an integrated ventilator with suction and exhaust duct used for sucking fresh air and for exhausting used air which has swept the print on the print carrier, the ventilator furthermore being connected with nozzles having a nozzle duct opening into an elongated nozzle orifice with orientation in parallel with the centre axis of the cylinder surface and disposed opposite to the cylinder surface for blowing an air stream towards a print on the print carrier while it is situated thereon.

2. Sheet offset machine according to claim 1, characterised in that at least one outermost part of the nozzle duct bordering the nozzle orifice is angled in relation to a position radially on the cylinder surface, so that the nozzle duct is directed against the direction of the movement of the print carrier past the drying unit.

3. Sheet offset machine according to claim 1, characterised in that the drying unit includes air withdrawal ducts which are arranged between succeeding nozzles and/or between the nozzles and sidewalls in the drying unit.

4. Sheet offset machine according to claim 3, characterised in that the air withdrawal ducts are provided with a plate at their orifice regions, the plate covering central parts of the orifice of the air withdrawal ducts at a level largely corresponding to the level of the nozzle orifices.

5. Sheet offset-machine according to claim 1, characterised in that the cylinder surface is provided in the shape of a counter pressure cylinder in a printing unit and/or varnishing unit or a transfer cylinder between succeeding printing units or a transfer roller after the last printing unit in the sheet offset machine.

6. Sheet offset machine according to claim 1, characterised in that the nozzles and the withdrawal suction ducts are built into a common casing, that in the said casing there is also mounted a motor with ventilator which is connected to the withdrawal ducts and with air supply ducts that are connected with the nozzle ducts and the exhausting ducts so that a substantial part of the air sucked into the ventilator is recycled in the casing and reused for injection, and that this part preferably is 80-90%.

7. Sheet offset machine according to claim 1, characterised in that the distance between the nozzle orifice and the surface of the print carrier is between 7 and 20 mm, preferably between 9 and 11 mm.

8. Drying unit for use in a sheet offset machine, which is possibly modified for applying an air-drying ink/varnish in at least one printing unit, the drying unit preferably disposed in association with a cylinder surface in the sheet offset machine, the drying unit including an integrated ventilator with suction and exhaust duct used for sucking in fresh air and for exhausting used air which has swept the print on the print carrier, the ventilator furthermore being connected with nozzles having a nozzle duct opening into an elongated nozzle orifice with orientation in parallel with the centre axis of the cylinder surface and disposed opposite to the cylinder surface for blowing an air stream towards a print on the print carrier while it is situated thereon.

9. Method for drying an air-drying ink/varnish in a sheet offset machine by injecting an air stream towards a print on a print carrier while the latter is moved by a drying unit at which the injection occurs against the print while the print carrier is situated on a cylinder surface in the sheet offset machine, that an integrated ventilator with suction and exhaust duct is used for sucking in fresh air and for exhausting used air that has swept the print on the print carrier, that the ventilator furthermore is used for injecting air through nozzles having a nozzle duct opening into an elongated nozzle orifice with orientation in parallel with the centre axis of the cylinder surface.

10. Method according to claim 9, characterised in that injection of air is performed at an angle in relation to a radial orientation so that the air stream is directed against the direction of movement of the print carrier past the drying unit.

11. Method according to claim 9, characterised in that the air withdrawal suction is performed at positions between succeeding air injections and/or between air injections and sidewalls in a drying unit, and that the air withdrawal suction is established in an orifice area which is partially blocked at central parts of an orifice region of an air withdrawal suction duct for forming a pressurised air cushion immediately over the print to be dried.

12. Method according to claim 9, characterised in that the drying is effected with a high-speed air stream with airspeeds at the nozzle orifice in the magnitude between 20 and 75 m/s, preferably between 35 and 50 m/s.

13. Method according to claim 9, characterised in that a substantial part of the air sucked in is recycled and reused for injection, and that this part preferably is higher than 80%, as the nozzles and the withdrawal ducts are integrated in a common casing including suction and exhaust ducts as well as withdrawal suction ducts and injection ducts which are connected to the nozzle ducts.
